(19) United States
(12) Patent Application Publication
(10) Pub. No.: US 2015/0123981 A1
(43) Pub. Date: May 7, 2015

(54) IMAGE DATA FORMING APPARATUS AND CONTROL METHOD THEREFOR

(71) Applicant: CANON KABUSHIKI KAISHA, Tokyo (JP)

(72) Inventor: Masanori Sato, Yokohama-shi (JP)

(21) Appl. No.: 14/531,871

(22) Filed: Nov. 3, 2014

(30) Foreign Application Priority Data
Nov. 6, 2013 (JP) 2013-230366
May 14, 2014 (JP) 2014-100828

(51) Int. Cl. G06T 1/60; G09G 5/00

(52) U.S. Cl. CPC G06T 1/60; G09G 5/001; G06T 2210/41; G09G 2360/18
USPC 345/535

(57) ABSTRACT

An image data forming apparatus includes a storage unit storing original image data, a buffer unit temporarily storing a part of the original image data, an output unit, a priority setting unit, a control unit, and an analysis unit. The output unit forms image data from the original image data, outputs the image data, and uses, if data needed to form the image data is stored in the buffer unit, the stored needed data. The priority setting unit divides the original image data into a blocks and set priorities for blocks. The control unit performs control so that image data of those blocks having a high priority is stored in the buffer unit by priority. The analysis unit analyzes, if the original image data is accompanied by data of annotations, position information about the annotations. The priority setting unit sets the priorities based on an analysis result.

### BACKGROUND OF THE INVENTION

1. Field of the Invention

The present invention relates to an image data forming apparatus and a control method thereof.

2. Description of the Related Art

In a pathological field, a virtual slide system is used as an alternative for an optical microscope serving as a tool for pathological diagnosis. The virtual slide system captures and digitizes an image of a test sample placed on a prepared slide to enable pathological diagnosis on a display. Since the pathological diagnosis is digitized by using the virtual slide system, conventional optical microscope images of test samples can be handled as digital data. The improvement of convenience can be expected in terms of the use of digital images for explanation to patients, sharing of rare cases, speedup of telediagnosis, and education and training efficiency.

An image viewer for visualizing the image data digitized by the virtual slide system is an interface which directly connects the system and a pathologist (i.e., user). The usability of the image viewer therefore has a large impact on the operability of the virtual slide system itself.

Conventional image viewers may have poor operability as compared to microscopes. For example, pathological image data typically has a huge size, e.g., several times to occasionally up to several hundred times the size of the region displayed on-screen. If such huge image data is displayed on an image viewer and scroll instructions are input to update the display data, the response of the screen display to the input can get delayed. Such a delay in response often causes stress on the user of the image viewer, sometimes becoming a factor against the widespread use of the virtual slide system. To improve the display response of the image viewer is thus extremely important because it can remove a barrier to the use of the virtual slide system by pathologists.

The improved display response of the image viewer is a challenge not limited to the virtual slide system, but a commonly recognized one. To solve such a problem, image data larger than the screen display region is usually stored in a buffer memory having relatively high access speed in advance. If a screen update occurs due to scrolling, the next display data is read from the buffer memory. The processing for reading image data or a part of the image data into a buffer area having high access speed in advance for the sake of improving the response of the screen display will hereinafter be referred to as “buffering”. Such processing may also be referred to as “caching”, and a memory used for caching may be referred to a “cache memory” or “cache”. As employed herein, a buffer and a cache will be used synonymously.

Buffering is a conventional, widely-known processing method. Typical buffering often includes reading a region larger than the screen display region by equal sizes in top, bottom, right, and left directions. In this case, the region actually displayed on-screen lies in the center of the image data region read into the buffer memory. Such a method is effective if the image displayed on-screen is changed by means of scrolling up, down, right, or left. However, if the amount of scroll at a time is large, the response of the image viewer can drop. The reason is that the next region to be displayed on-screen may be shifted to outside the buffered region, and the image data needs to be read from a storage device of which response is slower than the buffer memory. To avoid such a phenomenon, a larger buffer capacity can be provided, whereas the use efficiency of the buffer memory does not increase and most of the buffered data is still wasted. In general, to increase the display response of the image viewer, a larger buffer memory needs to be used.

The root cause of such problems is that the next display image is not accurately predictable. In other words, if the next display image can be predicted with a high probability, the use efficiency of the buffered data can be further improved.

As an example, Japanese Patent Application Laid-Open No. 2006-113801 discusses processing in which if image data includes text data, image contents are analyzed and data to be buffered is selected by using the characteristic that text is read in a specific direction. The method discussed in Japanese Patent Application Laid-Open No. 2006-113801 thereby achieves both speedup of scroll display and efficient memory use.

Other attempts have been made to further improve the use efficiency of buffered data (see Japanese Patent Applications Laid-Open Nos. 2013-167797 and 2013-167798).

In the situation discussed in Japanese Patent Application Laid-Open No. 2006-113801, the buffering utilizing the characteristic is effective since text is read in a fixed direction. However, some images may not include semantic data such as text (e.g., pathological images). Since directionality is not uniquely definable by the characteristics of such images, there is the problem that there is no buffering control method that achieves both speedup and efficient memory use. Japanese Patent Application Laid-Open No. 2006-113801 further has the problem that while it is effective when displaying a region adjacent to the current display image by scrolling, the response drops when displaying an image lying in a position far apart from the current display image.

### SUMMARY OF THE INVENTION

The present invention is directed to an image data forming apparatus that can improve display response and the use efficiency of a buffer memory.

According to an aspect of the present invention, an image data forming apparatus configured to form image data for display from original image data, includes a storage unit configured to store the original image data, a buffer unit configured to be capable of temporarily storing a part of the original image data, an output unit configured to form the image data for display from the original image data and output the image data for display, and configured to use, if data needed to form the image data for display is stored in the buffer unit, the needed data stored in the buffer unit, a priority setting unit configured to divide the original image data into a plurality of blocks and set priorities for respective blocks of the plurality of blocks, a control unit configured to perform control so that image data of those blocks having a high priority is stored in the buffer unit by priority, and an information analysis unit configured to analyze, if the original image data is accompanied by data of a plurality of annotations, position information about the plurality of annotations, wherein the priority setting unit is configured to set the priorities based on an analysis result of the information analysis unit.

Further features of the present invention will become apparent from the following description of exemplary embodiments with reference to the attached drawings.

### BRIEF DESCRIPTION OF THE DRAWINGS

FIG. 1 is a block diagram illustrating a system configuration of an image processing system according to a first exemplary embodiment.

FIG. 2 is a block diagram illustrating a hardware configuration of an image data forming apparatus according to the first exemplary embodiment.

FIG. 3 is a functional block diagram of the image data forming apparatus according to the first exemplary embodiment.

FIG. 4 is a diagram illustrating overall pathological image data.

FIG. 5 is a diagram illustrating a relationship between image data regions and annotations included in the pathological image data.

FIG. 6 is a flowchart illustrating an outline of a flow of image data forming processing according to the first exemplary embodiment.

FIG. 7 is a flowchart illustrating a flow of initial setting processing according to the first exemplary embodiment.

FIG. 8 is a flowchart illustrating a flow of analysis of position information according to the first exemplary embodiment.

FIG. 9 is a flowchart illustrating a flow of buffer content update processing according to the first exemplary embodiment.

FIG. 10 is a schematic diagram illustrating buffering priorities of the regions according to the first exemplary embodiment.

FIG. 11 is a schematic diagram illustrating an example of buffering according to the first exemplary embodiment.

FIG. 12 is a flowchart illustrating a flow of analysis of position information according to a second exemplary embodiment.

FIG. 13 is a schematic diagram illustrating buffering priorities of regions according to the second exemplary embodiment.

FIG. 14 is a schematic diagram illustrating an example of buffering according to the second exemplary embodiment.

FIG. 15 is a flowchart illustrating a flow of analysis of position information according to a third exemplary embodiment.

FIG. 16 is a schematic diagram illustrating buffering priorities of regions according to the third exemplary embodiment.

FIG. 17 is a schematic diagram illustrating an example of buffering according to the third exemplary embodiment.

FIG. 18 is a flowchart illustrating a flow of analysis of position information according to a fourth exemplary embodiment.

FIG. 19 is a diagram illustrating a relationship between image data regions and annotations according to the fourth exemplary embodiment.

FIG. 20 is a schematic diagram illustrating buffering priorities of regions according to the fourth exemplary embodiment.

FIG. 21 is a diagram illustrating another configuration example of the image processing system.

### DESCRIPTION OF THE EMBODIMENTS

An exemplary embodiment of the present invention relates to a technique for improving display response, when moving a display region, of an image viewer having a function of displaying an image corresponding to a part of original image data and changing the displayed image according to user's operations (scrolls and jumps). More specifically, an exemplary embodiment of the present invention relates to an apparatus for generating image data for display (display image data) from original image data, where data to be buffered is appropriately controlled to improve the use efficiency of a buffer memory and consequently improve the display response in a comprehensive manner.

More specifically, according to an exemplary embodiment of the present invention, the original image data is handled as a block image data group. The priority of buffering is determined with respect to each piece of block image data. Pieces of block image data having high priorities are buffered by priority. Such buffering priorities can be determined according to an analysis result of positions of annotations accompanying the original image data. Alternatively, the buffering priorities can be determined according to a combination of the analysis result of the positions of the annotations and an analysis result of other information associated with the annotations. In the following exemplary embodiments, an annotation refers to a marker attached to a specific position (point or area) in an image. Each annotation can be associated with position information in the image and information about pathological diagnosis. As employed herein, such information will be referred to collectively as “annotation information”. The “annotation information” includes the “position information” and “pathological diagnosis information”. The “pathological diagnosis information” refers to information that includes, for example, at least any one of information about the date of creation of an annotation, creator information, type information about the annotation, significance information (the state of a lesion or the degree of progress of a disease), diagnostic observation information, and other comments. If annotations are generated by automatic diagnostic software, the pathological diagnosis information may include diagnosis information generated by the automatic diagnostic software or information identifying the software. As employed herein, various types of information included in the “pathological diagnosis information” other than comment information or diagnosis information generated by automatic diagnostic software will be referred to collectively as “attribute information”. Depending on the context, markers and annotation information may be referred to collectively as “annotations”.

In virtual slide systems described in the following exemplary embodiments, important information such as observations in pathological diagnosis is written as comments in annotations. If an image includes an annotation, the image around the annotation is considered to be more likely to be viewed by a viewing user of the image as compared to other portions of the image. The image in the periphery of the annotation can thus be buffered in advance to improve the display response when the user gives a display request for the peripheral region. The effect is significant if the display request is given for a location that is far apart from the current display region and not able to be immediately displayed only by scroll processing. In other words, the position information about the annotation is utilized to predict data to be buffered. Even if the number of annotations is large or the capacity of the buffer memory is limited, only annotations satisfying a certain condition can be subjected to buffering. This enables buffering with high memory use efficiency.

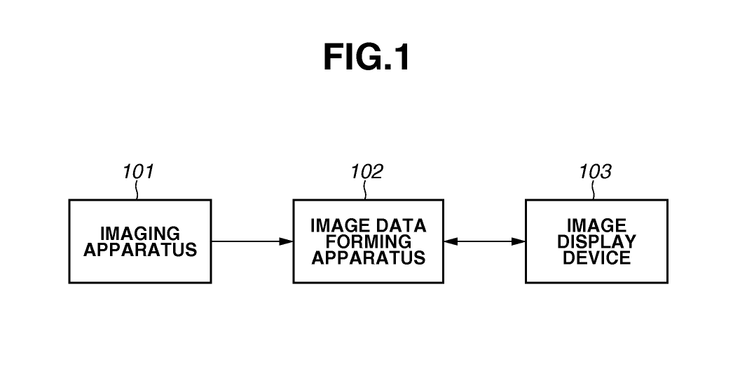

An image processing system according to a first exemplary embodiment of the present invention will be described with reference to the drawings. A method described in the present exemplary embodiment is implemented by a system configuration illustrated in FIG. 1. An imaging apparatus 101 mainly corresponds to an imaging unit of a virtual slide system. The imaging apparatus 101 is an apparatus for capturing an image of a slide (prepared slide) of a pathological sample serving as an object at high magnification and high resolution to obtain digital image data. The imaging apparatus 101 is also referred to as a digital microscope. An image data forming apparatus 102 is a main unit for implementing the method described in the present exemplary embodiment. More specifically, the image data forming apparatus 102 receives image data generated by the imaging apparatus 101 and performs processing for generating display image data. An image display device (display or monitor) 103 displays an image on-screen based on the display image data received from the image data forming apparatus 102.

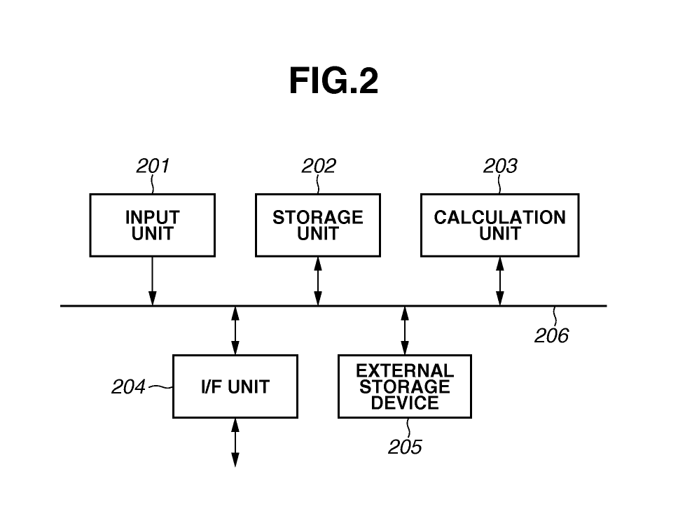

In the present exemplary embodiment, the image data forming apparatus 102 can be implemented, for example, by a computer including a hardware configuration illustrated in FIG. 2 and a program for providing various functions to be described below. An input unit 201 corresponds to a keyboard and/or a mouse. A storage unit 202 is a unit that stores the program for implementing the method described in the present exemplary embodiment and data to be processed. The storage unit 202 corresponds to a random access memory (RAM). A calculation unit 203 is a unit that performs various types of calculation processing on the data stored in the storage unit 202 according to the program stored in the storage unit 202. The calculation unit 203 corresponds to a central processing unit (CPU). An interface (I/F) unit 204 is an interface unit for controlling data input and output from/to the imaging apparatus 101 and the image display device 103. An external storage device (or auxiliary storage device) 205 corresponds to a hard disk or a flash memory. A data bus 206 connects the input unit 201, the storage unit 202, the calculation unit 203, the I/F unit 204, and the external storage device 205.

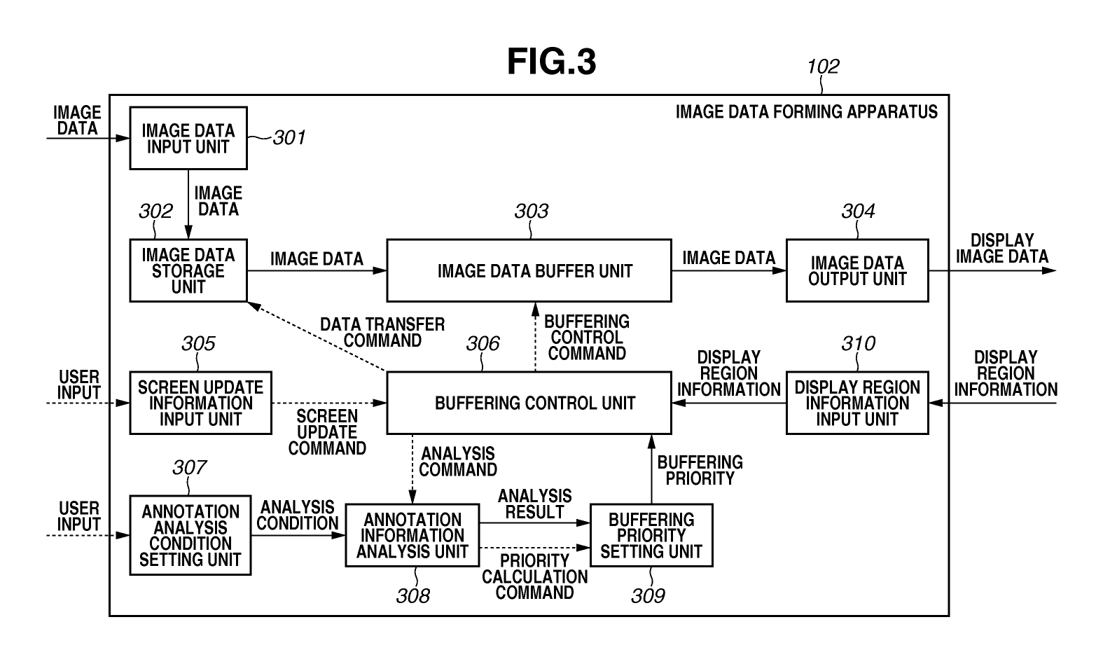

FIG. 3 illustrates a functional block diagram of the image data forming apparatus 102 according to the present exemplary embodiment. An image data input unit 301 is a unit that inputs the image data from the imaging apparatus 101. An image data storage unit (hereinafter, referred to as “storage unit”) 302 is a storage device for storing the image data input from the image data input unit 301. An image data buffer unit (hereinafter, referred to as “buffer unit”) 303 can receive a part of the image data from the storage unit 302 and temporarily store the data according to a buffering control command. The buffer unit 303 transfers data needed to form display image data to an image data output unit (hereinafter, referred to as “output unit”) 304. The storage unit 302 is constituted by using a large-capacity storage device (for example, the external storage device 205 in FIG. 2) since the storage unit 302 needs to store the entire image data. On the other hand, the buffer unit 303 is a storage device functioning as a buffer memory for image data. The buffer unit 303 is thus constituted by a device that can read and write data at higher speed as compared to the storage unit 302. In the present exemplary embodiment, the buffer unit 303 is configured inside the storage unit 202, whereas a dedicated buffer memory may be provided aside from the storage unit 202. The buffer unit 303 has a capacity smaller than that of the storage unit 302 and is not able to store the entire image data. In the following description, the buffer unit 303 may be referred to as a “buffer memory” or simply “buffer”. When inputting image data, the image data input unit 301 may receive a data transfer command from a buffering control unit (hereinafter, referred to as “control unit”) 306 and directly transfer the image data from the imaging apparatus 101 to the buffer unit 303 without the intervention of the storage unit 302.

The output unit 304 forms display image data to be output to the image display device 103 from the image data received from the storage unit 302 or the buffer unit 303. A screen update information input unit 305 accepts a user input, for example, from an input device such as a mouse, and transmits a screen update command to the control unit 306 based on the user input. The control unit 306 is a function for controlling the data to be stored in the buffer unit 303. The control unit 306 transmits a data transfer command to the storage unit 302. The control unit 306 receives display region information from a display region information input unit 310 and transmits a buffering control command to the buffer unit 303 based on the display region information. The control unit 306 further transmits a command to analyze annotation information accompanying the image data to an annotation information analysis unit (hereinafter, referred to as “information analysis unit”) 308. The control unit 306 receives buffering priority from a buffering priority setting unit (hereinafter, referred to as “priority setting unit”) 309.

An annotation analysis condition setting unit 307 generates an analysis condition needed for annotation information analysis from a user input, for example, and transmits the analysis condition to the information analysis unit 308. The annotation analysis condition setting unit 307 may generate the analysis condition by using other information stored in the image data forming apparatus 102 instead of a user input. Examples include organ information accompanying an image and viewing user information about an image.

The information analysis unit 308 analyzes the annotation information according to an analysis command received from the control unit 306, and transmits the result to the buffering priority setting unit 309. The information analysis unit 308 also transmits a priority calculation command to the buffering priority setting unit 309. The buffering priority setting unit 309 calculates buffering priority based on such information, and transmits the result to the control unit 306. The display region information input unit 310 obtains display region information retained by an operating system (OS), and transmits the result to the control unit 306.

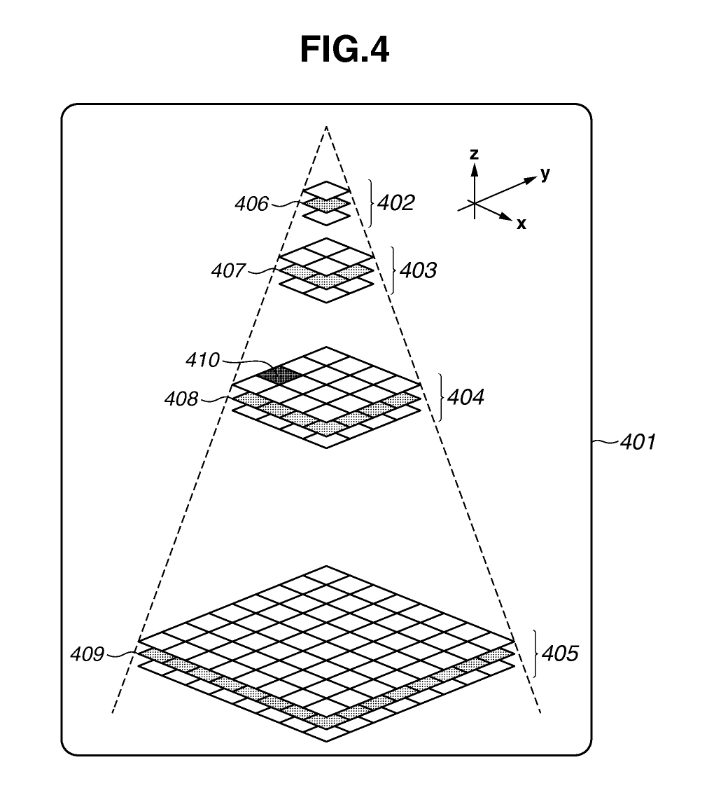

FIG. 4 is a diagram illustrating an overall structure of pathological image data. The present exemplary embodiment deals with image data having the structure illustrated in FIG. 4. Pathological image data 401 contains images of an object (pathological sample) captured by the imaging apparatus 101. The pathological image data 401 includes depth image groups 402 to 405 having different display magnifications of the object. In the present exemplary embodiment, the depth image groups 402 to 405 have a display magnification equivalent to 2.5 times, 5 times, 10 times, and 20 times, respectively. The expression “equivalent to xx times” is used to mean that the object image recorded in the corresponding image is similar to one observed under an optical microscope with an xx-power object lens. The depth image groups 402 to 405 each include a plurality of pieces of image data captured at different depths. The depth refers to a focal position (depth) of the imaging apparatus 101 in an optical axis direction. For example, pieces of image data 406 to 409 are ones that have different display magnifications and are all captured at the same depth.

All the pieces of image data constituting the pathological image data 401 are configured with block image data 410 as a minimum unit. In the present exemplary embodiment, processing such as data transfer is performed in units of such block image data 410. Each piece of block image data 410 may be an independent image file. The image data 406 to 409 may be respective independent image files, and block image data 410 may be defined as a unit for internal handling. All the pieces of block image data 410 can be uniquely identified by indexes (i, j, k, l) which include a plurality of integers. In the present exemplary embodiment, i is an index in an x-axis direction, j is an index in a y-axis direction, k is an index in a z-axis (depth) direction, and l is an index in a magnification direction. For example, if there are two pieces of block image data 410 having the same indexes i and j, and index l is the same, the pieces of block image data 410 are indicated to be in the same position on an xy plane. The pieces of block image data 410 belonging to the same depth image group all have an index l of the same value.

The pathological image data 401 illustrated in FIG. 4 can be generated by capturing images of an object (pathological sample) by the imaging apparatus 101 a plurality of times at different capturing magnifications and different focal positions in the optical axis direction. Various types of data accompanying the object or image groups may be added to the pathological image data 401. Examples include the foregoing annotations. Annotation data includes at least position information about an annotation (marker) and pathological diagnosis information associated with the annotation. Position information about an annotation can be defined, for example, by a combination of indexes specifying block image data 410 and xy coordinates in the block image data 410 or xy coordinates in the image data 408. An annotation may be attached to an area having a certain extent instead of a point. In such a case, the position information on the annotation may include, for example, the coordinates of two diagonal points of a rectangular area or the center coordinates and radius of a circular area. If a plurality of annotations is added to a single piece of pathological image data 401, annotation data is generated for each of the plurality of annotations. Examples of the annotation data will be described below.

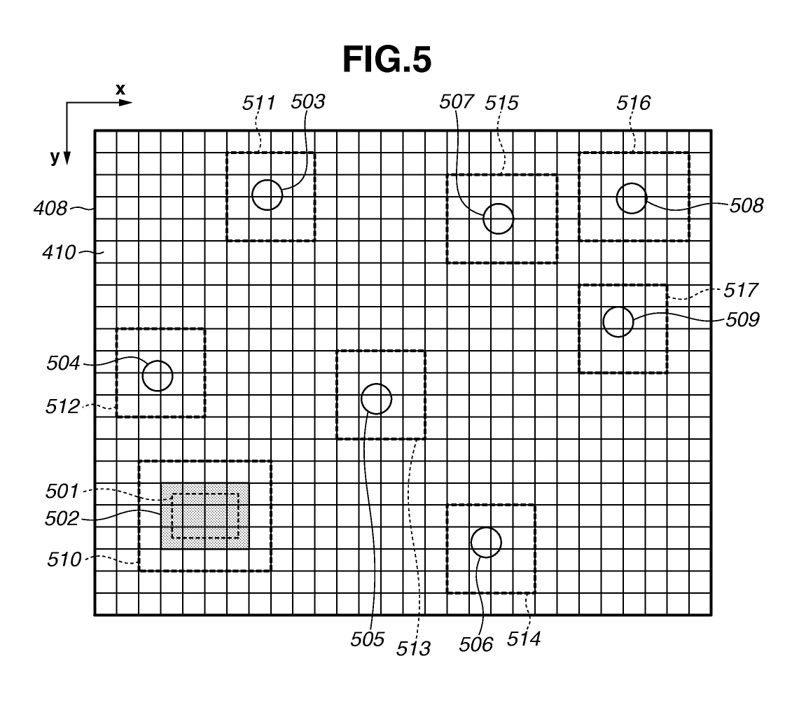

FIG. 5 illustrates a method for handling image data according to the present exemplary embodiment. FIG. 5 illustrates a case where the image data 408 in the pathological image data 401 is to be displayed on-screen. The image display device 103 actually displays a region 501 on-screen. The region 501 will hereinafter be referred to as “screen display region”. An image region 502 is to be transferred to the image display device 103 for screen display. The image region 502 will hereinafter be referred to as “display data region”. In the present exemplary embodiment, the display data region 502 is defined as a region that includes the entire image display region 501 and includes a minimum number of pieces of block image data 410. In some cases, the display data region 502 may be defined as a region greater than such a definition. The screen display region 501 and the display data region 502 may coincide with each other.

There are annotations 503 to 509 associated onto the image. The annotations 503 to 509 are represented by circular figures which have a size greater than a piece of block image data 410. In some cases, the annotations 503 to 509 may be represented by figures other than circular ones. The size of the annotations 503 to 509 may be smaller than a piece of block image data 410. The pathological image data 401 including the image data 408 is accompanied by annotation data corresponding to the annotations 503 to 509. In the present exemplary embodiment, the annotation data includes, for example, an identification (ID) number, a position (specified by x and y coordinates) on the image, a creator, date of creation, and a comment. Table 1 illustrates an example of the annotation data. The x and y coordinates in Table 1 have an origin at the top left corner of the image data 408. The x and y coordinates are expressed in units of pixels.

TABLE 1

| | X | Y | | Date of | |
|---|---|---|---|---|---|
| ID | coordinate | coordinate | Creator | creation | Comment |
| 1 | 790 | 300 | Sakoda | 2012 Dec. 18 | AAA . . . |
| 2 | 310 | 1110 | Sakoda | 2012 Dec. 18 | BBB . . . |
| 3 | 1290 | 1210 | Iwasaka | 2013 Feb. 9 | CCC . . . |
| 4 | 1790 | 1860 | Kimura | 2012 Aug. 21 | DDD . . . |
| 5 | 1840 | 400 | Shinnabe | 2013 Apr. 7 | EEE . . . |
| 6 | 2440 | 300 | Sakoda | 2013 Jun. 12 | FFF . . . |
| 7 | 2380 | 860 | Shinnabe | 2013 Oct. 5 | GGG . . . |

In the present exemplary embodiment, the annotations 503 to 509 correspond to the annotation data of IDs 1 to 7, respectively.

The sizes of regions 510 to 517 to be buffered (margins of buffering) can be specified in advance or changed by the user or the program. The regions 510 to 517 will hereinafter be referred to as “buffering target regions”. There are two types of buffering target regions, including a first buffering target region 510 associated with the image display region 501, and second buffering target regions 511 to 517 associated with the positions to which the annotations 503 to 509 are added.

In the present exemplary embodiment, the first buffering target region 510 is defined as a region that is greater than the display data region 502 by one piece of block image data 410 in each of the top, bottom, right, and left directions and does not include the display data region 502. In other words, the first buffering target region 510 is a block image data group including a row of pieces of block image data 410 around the display data region 502. The first buffering target region 510 may include the display data region 502 if needed. In the present exemplary embodiment, the second buffering target regions 511 to 517 are each defined as a region greater than a minimum region needed to fully include the respective annotations 503 to 509 by one piece of block image data 410 in each of the top, bottom, right, and left directions.

The definition ranges of the buffering target regions 510 to 517 are not limited to the foregoing examples and may be modified as appropriate. For example, in FIG. 5, a single row of blocks around (on the top, bottom, right, and left of) the display data region 502 of an annotation region is provided as a buffering margin. However, two or more rows of blocks around may be included in a buffering target region. The margin widths (the numbers of rows of blocks) on the top, bottom, right, and left may be different. For example, if it is known in advance that scrolling in the horizontal direction (x direction) is used more often than in the vertical direction (y direction), one row of blocks on the top and bottom and two rows of blocks on the right and left may be set as a buffering target region.

In FIG. 5, the block image data 410 to be buffered is selected from the image data having the same depth as that of the display image displayed on the image viewer (image data 408). However, the buffering target regions 510 to 517 may be extended in the depth direction. More specifically, data on the corresponding portions of image data having a different depth from that of the display image may be selected as a buffering target along with the data on the annotation portions of the image data 408 having the same depth as that of the display image. For example, if the block image data 410 on an annotation portion has indexes (i, j, k, l), the buffering target region may include block image data 410 having indexes (i, j, k±p, l). Such buffering is effective if the image viewer has a function of changing the display image in the depth direction (depth scrolling). p is a positive integer other than 0. The buffering target regions 510 to 517 may be extended in the magnification direction. More specifically, data on the corresponding portions of image data having a different magnification from that of the display image may be selected as a buffering target along with the data on the annotation portions of the image data 408 having the same magnification as that of the display image. For example, if the block image data 410 on an annotation portion has indexes (i, j, k, l), the buffering target region may include block image data 410 having indexes (i′, j′, k, l±q). Such buffering is effective if the image viewer has a function of switching the display magnification. q is a positive integer other than 0. In most cases, i and i′, and j and j′, have different values. The buffering target regions 510 to 517 may be extended both in the depth direction and the magnification direction at the same time.

### <Image Data Forming Processing>

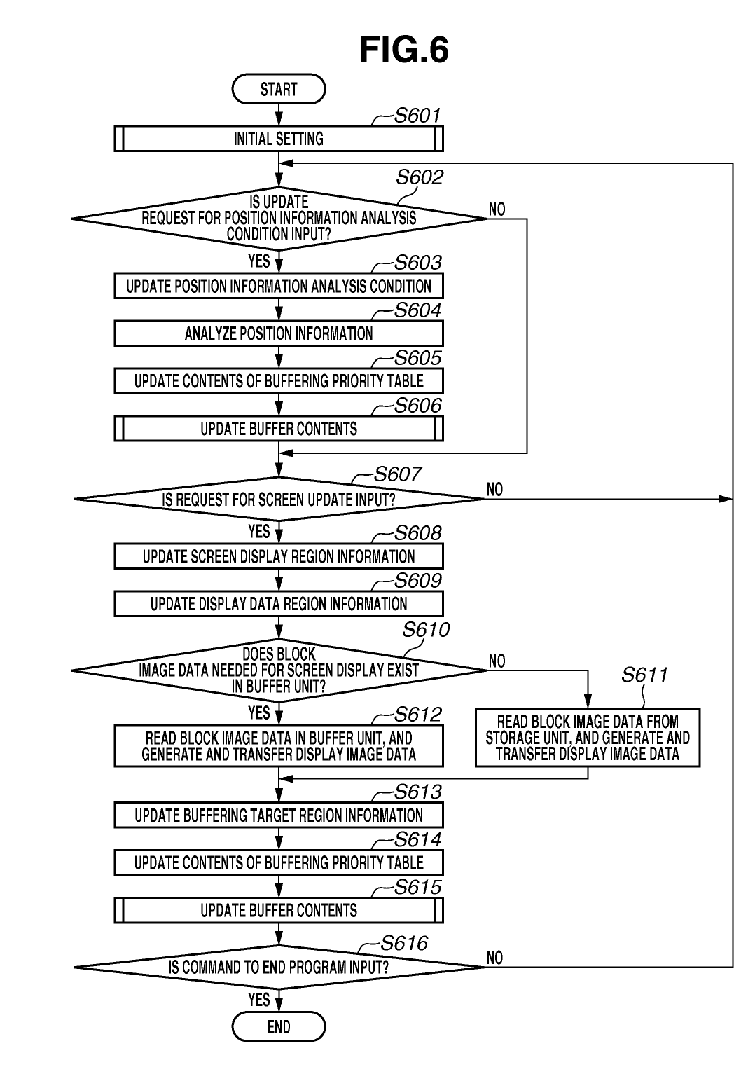

FIG. 6 is a flowchart illustrating an outline of a flow of image data forming processing according to the present exemplary embodiment. The flow of the image data forming processing will be described below with reference to FIG. 6.

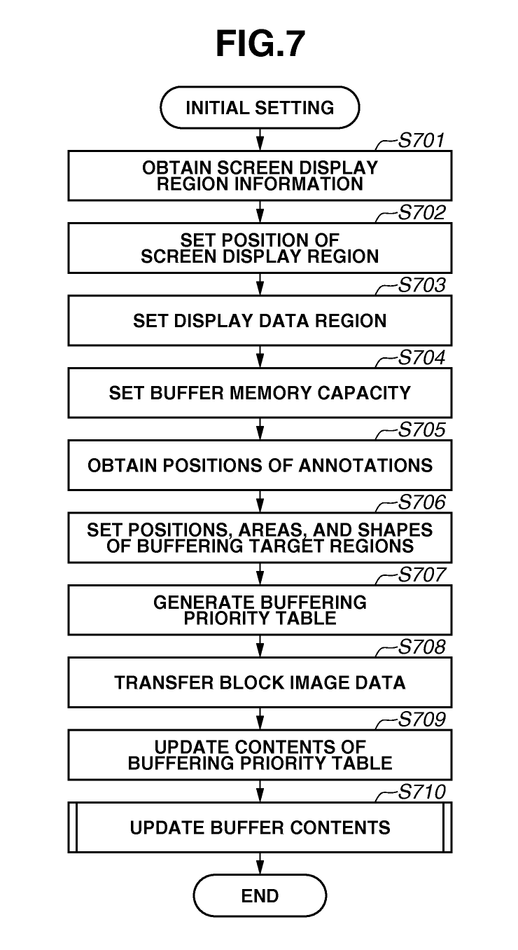

In step S601, the control unit 306 performs initial setting. In step S601, the control unit 306 further performs processing illustrated in FIG. 7. A detailed processing flow of the initial setting will be described below.

Next, in step S602 (condition determination), the annotation analysis condition setting unit 307 determines whether an update request for a position information analysis condition of annotations is input to the image data forming apparatus 102 in the form of a user input. The update request for a position information analysis condition refers to an operation of changing a condition to determine what analysis to perform on position information about an annotation and what buffering priority to set based on the analysis result. The user input can be made, for example, by displaying a screen for inputting an analysis condition on the image display device 103 and allowing the user to select or input an analysis method to use and a condition to determine priority by using an input device such as a mouse. The annotation analysis condition setting unit 307 may automatically set the analysis condition.

In the condition determination of step S602, if an update request for a position information analysis condition is determined to be input (YES in step S602), then in step S603, the annotation analysis condition setting unit 307 updates the position information analysis condition based on the input. More specifically, the annotation analysis condition setting unit 307 rewrites data on the position information analysis condition stored in the storage unit 202. If an update request for a position information analysis condition is determined not to be input (NO in step S602), the processing proceeds to step S607.

In step S604, the information analysis unit 308 analyzes annotation information (position information) according to the position information analysis condition. The specific processing content of step S604 varies depending on the position information analysis condition set in step S603. In the present exemplary embodiment, the information analysis unit 308 increases the buffering priorities near annotations positioned close to the screen display region 501. A detailed flow of the processing will be described below. Such processing is performed based on the assumption that the closer the distance of an annotation is from the screen display region 501, the more closely the stored information is associated with the current screen display region 501 and the more likely the annotation is to be referred to than other annotations. More specifically, for example, if screen display is targeted for a lesion, nearby annotations may contain information about the same lesion as that of the display region. The analysis result of the information analysis unit 308 (for example, a list of ID numbers of annotations extracted and sorted) is passed to the buffering priority setting unit 309.

Next, the buffering priority setting unit 309 determines buffering target regions based on the analysis result of step S604. The buffering priority setting unit 309 refers to the position information about the annotations extracted in step S604 and sets the buffering target regions 511 to 517 to include the respective annotation portions. In step S605, the buffering priority setting unit 309 determines the buffering priority of each piece of block image data 410 lying in the buffering target regions 511 to 517, and updates the contents of an already-generated buffering priority table. The buffering priority table is a table generated in step S707 during the initial setting of step S601. Step S707 will be described below.

The buffering priority table is a table including the ID numbers of the respective pieces of block image data 410 in the buffering target regions 510 to 517, the ID numbers of the corresponding buffering target regions 510 to 517, and buffering priorities. The ID numbers corresponding to the respective pieces of block image data 410 correspond to the index numbers also uniquely specifying the pieces of block image data 410 on a one-to-one basis. In the present exemplary embodiment, the buffering target region 510 has an ID number of 0. The ID numbers of the buffering target regions 511 to 517 coincide with the ID numbers of the annotations 503 to 509 to which the buffering target regions 511 to 517 belong (in other words, integers of 1 to 7 are assigned in order). In the present exemplary embodiment, the buffering priority has a positive integer value. The higher the value is, the higher the buffering priority is. The buffering priority may be defined differently, for example, by using positive and negative real numbers if needed. Table 2 illustrates an example of the buffering priority table.

TABLE 2

| Block image data | Buffering target | Buffering |
|---|---|---|
| ID | region ID | priority |
| 37 | 0 | 9 |
| 38 | 0 | 9 |
| 39 | 0 | 9 |
| . | . | . |
| . | . | . |
| . | . | . |
| 123 | 1 | 0 |
| 124 | 1 | 0 |
| . | . | . |
| . | . | . |
| . | . | . |
| 376 | 3 | 1 |
| 377 | 3 | 1 |
| . | . | . |
| . | . | . |
| . | . | . |

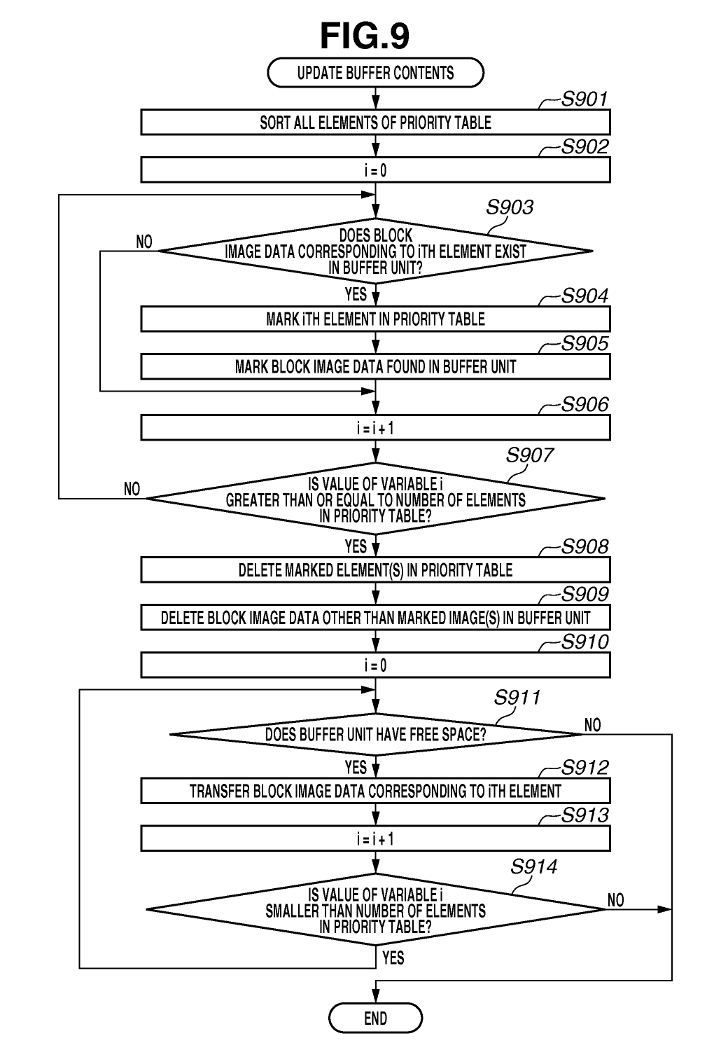

In step S606, the control unit 306 updates the data stored in the buffer unit 303 (referred to as “buffer contents”) based on the contents of the buffering priority table updated in step S605. If the buffer contents do not necessarily need to be updated, the processing of step S606 may be omitted in view of processing efficiency as long as appropriate. Examples of such a situation include when the result from the updated analysis condition coincides with that from the analysis condition before updated. There are several possible methods for the specific processing of step S606. FIG. 9 illustrates an example thereof. A detailed description of FIG. 9 will be given below.

Next, in step S607, the control unit 306 determines whether any form of request for screen update is input to the image data forming apparatus 102. Examples of the request for screen update include a screen scroll instruction given from an input device such as a mouse, and a screen switch instruction. If a request for screen update is not input (NO in step S607), the processing returns to step S602.

In step S607, if a request for screen update is determined to be input (YES in step S607), then in step S608, the control unit 306 updates screen display region information based on the input. As employed herein, the “screen display region information” refers to information about the position and display area of the screen display region 501 with respect to the image data 408.

In step S609, the control unit 306 updates display data region information based on the updated screen display region information. As employed herein, the “display data region information” refers to information about the position and area of the display data region 502 with respect to the image data 408.

In step S610, the control unit 306 determines whether block image data 410 needed for image display exists in the buffer unit 303. If the control unit 306 determines that the block image data 410 exists in the buffer unit 303 (YES in step S610), the processing proceeds to step S612. In step S612, the output unit 304 reads the block image data 410 in the buffer unit 303, and generates and transfers display image data to the image display device 103. If the control unit 306 determines that the block image data 410 does not exist in the buffer unit 303 (NO in step S610), the processing proceeds to step S611. In step S611, the output unit 304 reads the block image data 410 from the storage unit 302, and generates and transmits display image data to the image display device 103. The output unit 304 may simply transfer the block image data 410 as the display image data. The output unit 304 may apply necessary image processing (for example, resolution conversion, gradation correction, color correction, enhancement processing, synthesis processing, and/or format conversion) to the block image data 410 to generate the display image data.

In step S613, the control unit 306 updates buffering target region information. As employed herein, the “buffering target region information” refers to information about the position, shape, and a buffering region range of the buffering target region 510 with respect to the image data 408. For the sake of simplicity, in the present exemplary embodiment, the positional relationship between the display data region 502 and the buffering target region 510 and the shape of the buffering target region 510 are assumed to remain unchanged. However, the buffering target region 510 and the other buffering target regions 511 to 517 may overlap each other if the position of the buffering target region 510 is changed.

In step S614, the buffering priority setting unit 309 updates the contents of the already-generated buffering priority table. If the buffering target region 510 does not overlap the buffering target regions 511 to 517, the buffering priority setting unit 309 sets a predetermined priority for the block image data 410 belonging to the buffering target region 510. For example, higher priority may always be given to the block image data 410 belonging to the buffering target region 510 than to the other block image data 410. Such setting is performed based on the assumption that the screen display region 501 is more likely to be moved by scrolling up, down, right, or left than by jumping to other distant regions. If the buffering target region 510 overlaps any of the buffering target regions 511 to 517, the buffering priority setting unit 309 sets priorities as if the block image data 410 lying in the overlapping region(s) belongs to the buffering target region 510.

In step S615, the control unit 306 updates the buffer contents stored in the buffer unit 303 based on the contents of the buffering priority table updated in step S614. According to the algorithm illustrated in FIG. 6, the buffer contents are always updated if a request for screen update is input. However, if the buffer contents do not necessarily need to be updated, like when the amount of scroll is small, the processing of step S615 may be omitted in view of processing efficiency as appropriate. The specific processing of step S615 is similar to that of step S606, which will be described below with reference to FIG. 9.

After step S615, in step S616, the control unit 306 determines whether a command to end the program is input. If the control unit 306 determines that the command to end the program is input (YES in step S616), the control unit 306 ends the program. If the control unit 306 determines that the command to end the program is not input (NO in step S616), the processing returns to the condition determination of step S602, and the annotation analysis condition setting unit 307 continues the processing.

That is the outline of the flow of the image data forming processing according to the present exemplary embodiment.

### <Initial Setting in Step S601>

FIG. 7 is a flowchart illustrating a detailed flow of the initial setting in step S601 according to the present exemplary embodiment. A description will be given below with reference to FIG. 7.

In step S701, the control unit 306 obtains screen display region information from the display region information input unit 310. The screen display region information refers to information about display screen resolution.

In step S702, the control unit 306 sets the position of the screen display region 501 in the image data 408 having the depth and magnification to be displayed. The position and area for the screen display region 501 to occupy in the image data 408 are determined by the information about the display screen resolution obtained in step S701 and the information about the position set in step S702. For example, the depth, magnification, and region for initial display may be set to the center region of the image data 408 having the central depth and magnification in the pathological image data 401.

In step S703, the control unit 306 sets the display data region 502 based on the screen display region 501 determined in step S702. The position and area of the display data region 502 are determined in step S703.

In step S704, the control unit 306 sets a buffer memory capacity. The buffer memory capacity is set by the user or the program according to the capacity of the storage unit 202 mounted on the image data forming apparatus 102.

In step S705, the control unit 306 obtains the positions of the annotations 503 to 509 associated with the image data 408. This corresponds to, for example, obtaining the annotation data accompanying the pathological image data 401 and obtaining the center positions and radii of the annotations 503 to 509 on the image data 408.

In step S706, the control unit 306 sets the positions, areas, and shapes of the buffering target regions 510 to 517. The control unit 306 makes such settings as described above.

In step S707, the control unit 306 generates a buffering priority table for storing the buffering priorities of the respective pieces of block image data 410 lying in the buffering target regions 501 to 517. As has been described in conjunction with step S605, the buffering priority table is a table including the ID numbers of the respective pieces of block image data 410 in the buffering target regions 510 to 517, the ID numbers of the corresponding buffering target regions 510 to 517, and the buffering priorities thereof. At this point in time, the values of the buffering priorities are not calculated yet. The control unit 306 therefore sets the buffering priorities to a certain value such as zero.

In step S708, the output unit 304 reads the block image data 410 on the region corresponding to the display data region 502 from the storage unit 302 and transfers the block image data 410 to the image display device 103 under control of the control unit 306.

In step S709, the buffering priority setting unit 309 updates the buffering priority table based on the information about the display data region 502 transferred to the image display device 103. In step S709, the buffering priority setting unit 309 sets a predetermined priority for only elements corresponding to the block image data 410 belonging to the buffering target region 510 (i.e., only the block image data 410 around the region displayed in step S708) among the elements of the buffer priority table. The processing of this step S709 is similar to that of step S614.

In step S710, the control unit 306 updates the buffer contents based on the buffering priority set in step S709. The processing of this step S710 is similar to that of steps 606 and S615.

That is the end of the initial setting processing in step S601.

### <Analysis of Position Information in Step S604>

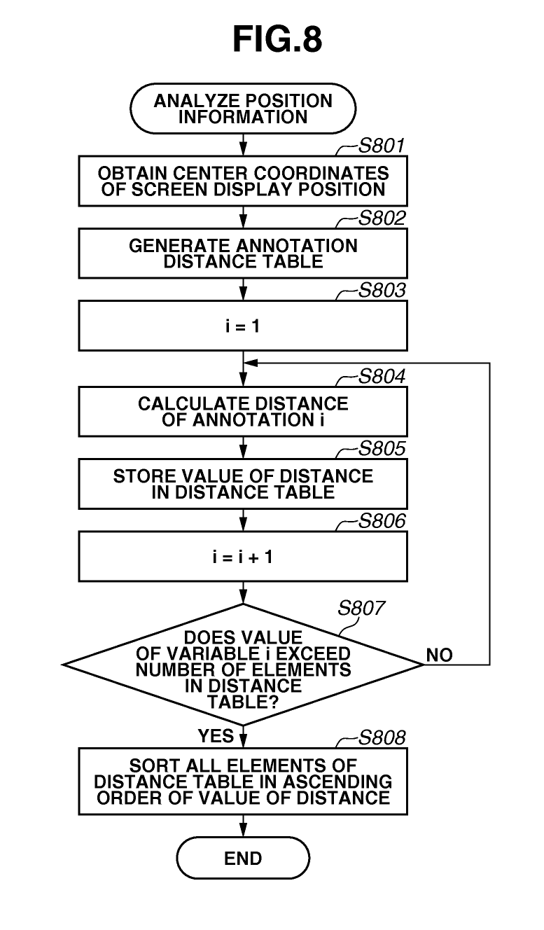

FIG. 8 is a flowchart illustrating an example of a detailed flow of position information update processing performed in step S604 according to the present exemplary embodiment. A description will be given below with reference to FIG. 8.

In step S801, the information analysis unit 308 obtains the center coordinates of a screen display position. The center coordinates are expressed in a coordinate system in unit of pixels, with an origin at the top left corner of the image data 408.

In step S802, the information analysis unit 308 generates an annotation distance table (hereinafter, referred to as “distance table”) for storing distances between the center coordinates of the screen display position obtained in step S801 and the center coordinates of respective annotations. The distance table is a table including the ID numbers of the annotations and the distances between the center coordinates of the corresponding annotations and those of the screen display position. At this point in time, the distance values are not calculated yet. The information analysis unit 308 therefore sets the distance values to a certain value such as zero.

In step S803, the information analysis unit 308 prepares an integer variable i and sets the variable i to one.

In step S804, the information analysis unit 308 calculates the distance between the center coordinates of the screen display position obtained in step S801 and the center coordinates of an annotation having an ID number of i.

In step S805, the information analysis unit 308 stores the value of the distance calculated in step S804 in the distance table.

In step S806, the information analysis unit 308 increases the value of the variable i by one. In step S807, the information analysis unit 308 checks whether the value of the variable i exceeds the number of elements (the number of annotations) in the distance table. If the information analysis unit 308 determines that the value of the variable i does not exceed the number of elements (NO in step S807), the processing returns to step S804 to continue the position information analysis processing. If the information analysis unit 308 determines that the value of the variable i exceeds the number of elements (YES in step S807), the processing proceeds to step S808 since there is no annotation left to calculate the distance thereof. In step S808, the information analysis unit 308 sorts all the elements of the distance table in ascending order of the value of the distance. The information analysis unit 308 generates a list of annotation ID numbers from the sorted result, and passes the list to the buffering priority setting unit 309. The buffering priority setting unit 309 uses the passed list when updating the buffering priority table in step S605.

That is the end of the detailed description of FIG. 8.

### <Updating of Buffer Contents in Steps S606, S615, and S710>

FIG. 9 is a flowchart illustrating an example of a detailed flow of buffer content update processing in steps S606, S615, and S710 according to the present exemplary embodiment. A description will be given below with reference to FIG. 9.

In step S901, the control unit 306 sorts all the elements of the buffering priority table (hereinafter, referred to as “priority table”) in descending order of the priority.

In step S902, the control unit 306 prepares an integer variable i and sets the variable i to zero.

In step S903, the control unit 306 checks whether block image data 410 corresponding to the i-th element in the priority table already exists in the buffer unit 303. More specifically, for example, the control unit 306 may generate a list of ID numbers corresponding to pieces of block image data 410 existing in the buffer unit 303 in advance, and check the generated list for the ID number corresponding to the block image data 410 of the i-th element. If the control unit 306 determines that the block image data 410 corresponding to the i-th element in the priority table already exists in the buffer unit 303 (YES in step S903), then in step S904, the control unit 306 marks the i-th element in the priority table. In step S905, the control unit 306 marks the block image data 410 found in the buffer unit 303. Flags may be associated with the marks. If the control unit 306 determines that the block image data 410 corresponding to the i-th element in the priority table does not exist in the buffer unit 303 (NO in step S903), the processing proceeds to step S906.

In step S906, the control unit 306 increases the value of the variable i by one.

In step S907, the control unit 306 checks whether the value of the variable i is greater than or equal to the number of elements in the priority table. If the control unit 306 determines that the value of the variable i is smaller than the number of elements in the priority table (NO in step S907), the processing returns to the condition determination of step S903. If the control unit 306 determines that the value of the variable i is greater than or equal to the number of elements in the priority table (YES in step S907), then in step S908, the control unit 306 deletes the marked element(s) in the priority table. As a result, only elements not existing in the buffer unit 303 (i.e., pieces of block image data 410 to be added to the buffer unit 303) among the pieces of block image data 410 having high priority remain in the priority table. After step S908, in step S909, the control unit 306 deletes the buffered block image data 410 except that of the marked image(s). As a result, block image data 410 that does not need to be buffered is deleted to make a free space in the buffer unit 303.

In step S910, the control unit 306 substitutes 0 into the variable i.

In step S911, the control unit 306 determines whether the buffer unit 303 has free space. If the control unit 306 determines that the buffer unit 303 has free space (YES in step S911), then in step S912, the control unit 306 transfers the block image data 410 corresponding to the i-th element of the priority table from the storage unit 302 to the buffer unit 303.

In step S913, the control unit 306 increases the value of the variable i by one. In step S914, the control unit 306 checks whether the value of the variable i is smaller than the number of elements in the priority table. If the control unit 306 determines that the value of the variable i is smaller than the number of elements in the priority table (YES in step S914), the processing returns to step S911 to continue the processing for updating the buffer contents. If the control unit 306 determines that the value of the variable i is not smaller than the number of elements in the priority table (NO in step S914), the processing for updating the buffer contents ends since there is no block image data 410 left to be buffered. If the determination result of the condition determination in step S911 is false (NO in step S911), the processing for updating the buffer contents ends since no more image data can be stored in the buffer unit 303.

That is the end of the detailed description of FIG. 9. In addition, the buffer content update processing of steps S606, S615, and S710 may be performed by processing other than illustrated in FIG. 9. For example, all the contents in the buffer unit 303 may be simply deleted and block image data groups having high buffering priorities may be read into the buffer unit 303 in order.

### <Example of Buffering>

Next, how block image data 410 is stored into the buffer unit 303 when the processing of FIGS. 6 to 9 is performed will be described by using an example.

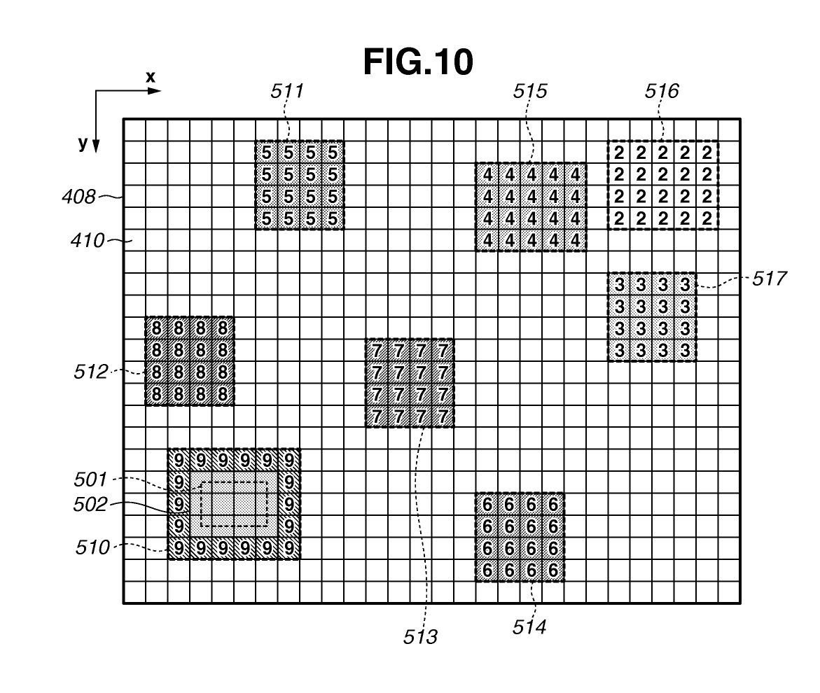

For example, suppose that the buffering target regions 510 to 517 include block image data groups for which the buffering priorities illustrated in FIG. 10 are set. FIG. 10 illustrates a state where higher priorities are set for the images around annotations having smaller values of distance from the screen display region 501 by using the position information about the annotation data of Table 1. A higher priority of “9” is set for the block image data 410 belonging to the buffering target region 510, i.e., the block image data 410 corresponding to the peripheral region of the portion displayed on the image viewer. In the present exemplary embodiment, the priorities are set based on the following assumption. The assumption is that the screen display region 501 is more likely to be moved by scrolling up, down, right, or left than by jumping to other distant regions, i.e., near the buffering target regions 511 to 517. The block image data 410 belonging to the buffering target region 510 thus has a higher priority of buffering than those of the block image data 410 belonging to the buffering target regions 511 to 517. The priority of the block image data 410 belonging to the buffering target region 510 may be set to a number other than “9” as long as the number is higher than the priorities of the block image data 410 belonging to the buffering target regions 511 to 517.

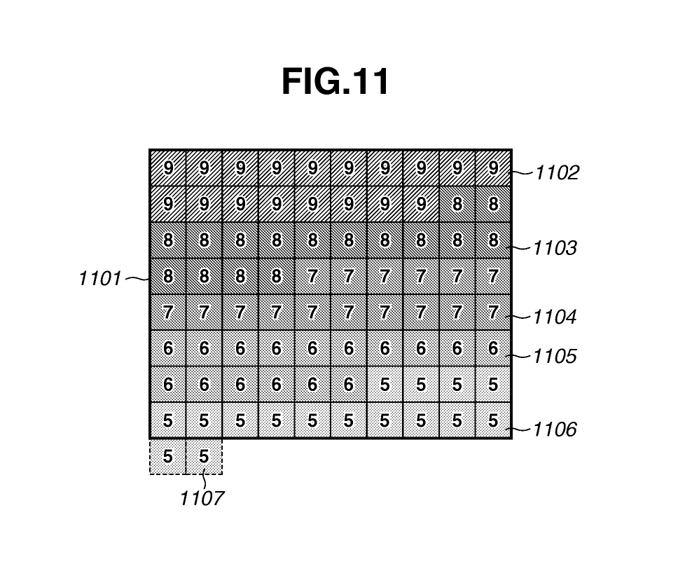

FIG. 11 illustrates how block image data groups are stored in the buffer unit 303 with such priority settings. In the situation illustrated in FIG. 11, a buffer area 1101 has a size smaller than the total sum of the block image data 410 to be buffered. All the block image data 410 are therefore not able to be stored in the buffer unit 303. In such a case, block image data groups 1102, 1103, 1104, 1105, and 1106 are buffered in order. The block image data groups 1106 and 1107 both belong to the buffering target region 511, whereas only the block image data group 1106 is actually buffered due to the limited size of the buffer area 1101.

The block image data 410 to be stored in the buffer unit 303 may be either compressed data or uncompressed data. If an emphasis is placed on the speedup of the display processing, compressed data may desirably be decompressed and stored in the buffer unit 303 in the form of uncompressed data during a wait time of the program. If an emphasis is placed on the reduction of the buffer memory capacity, compressed data may desirably be stored without decompression.

In the present exemplary embodiment, the positions of the annotations 503 to 509 are expressed by two-dimensional coordinates. However, pathological images to be handled may include a depth image group and a plurality of annotations may exist in different depth images in the same depth image group in a distributed manner. In such a case, the positions of the annotations may be expressed by three-dimensional coordinates, and distances may be calculated based thereon. For example, the depth position of each depth image can be converted into a z coordinate by using an appropriate method.

As described above, according to the present exemplary embodiment, image data can be buffered with high memory use efficiency according to the characteristics of the pathological diagnosis as compared to the conventional technique. As a result, the display response of the image viewer improves. More specifically, the position information about the annotation data accompanying the pathological images can be analyzed and the buffering priorities of image data near annotations close to the current display position can be increased to enable buffering processing with memory use efficiency higher than heretofore.

A second exemplary embodiment of the present invention will be described with reference to the drawings.

An outline of the system configuration, hardware configuration, functional blocks, and processing algorithm is similar to that of the first exemplary embodiment. Differences lie in the condition for the analysis of position information about annotations and the method for buffering image data.

In the first exemplary embodiment, the buffering priorities of images around the annotations 503 to 509 are determined depending on the distances from the screen display region 501. On the other hand, in the present exemplary embodiment, high buffering priorities are set for images around annotations of which an annotation number density has a high value. This is performed based on the assumption that regions where annotations are concentrated are more likely to be referred to than other regions. The annotation number density of an annotation A refers to an index that indicates how many annotations there are around the annotation A other than itself. For example, assuming a radius R around the annotation A, the annotation number density is calculated as the number of annotations lying within the radius R except the annotation A. Instead of assuming a circle having the radius R, the annotation number density may be calculated, for example, by assuming a square or rectangle having a specific size around the annotation A and calculating the number of annotations lying in the square or rectangle except the annotation A. It will be understood that the annotation number density may be calculated by using other appropriate methods.

The present exemplary embodiment uses similar processing to that of the first exemplary embodiment as far as FIGS. 6, 7, and 9 are concerned. Specific processing for the analysis of position information in step S604 is different from that of the first exemplary embodiment. A flow of step S604 according to the present exemplary embodiment will be described below.

### <Analysis of Position Information in Step S604>

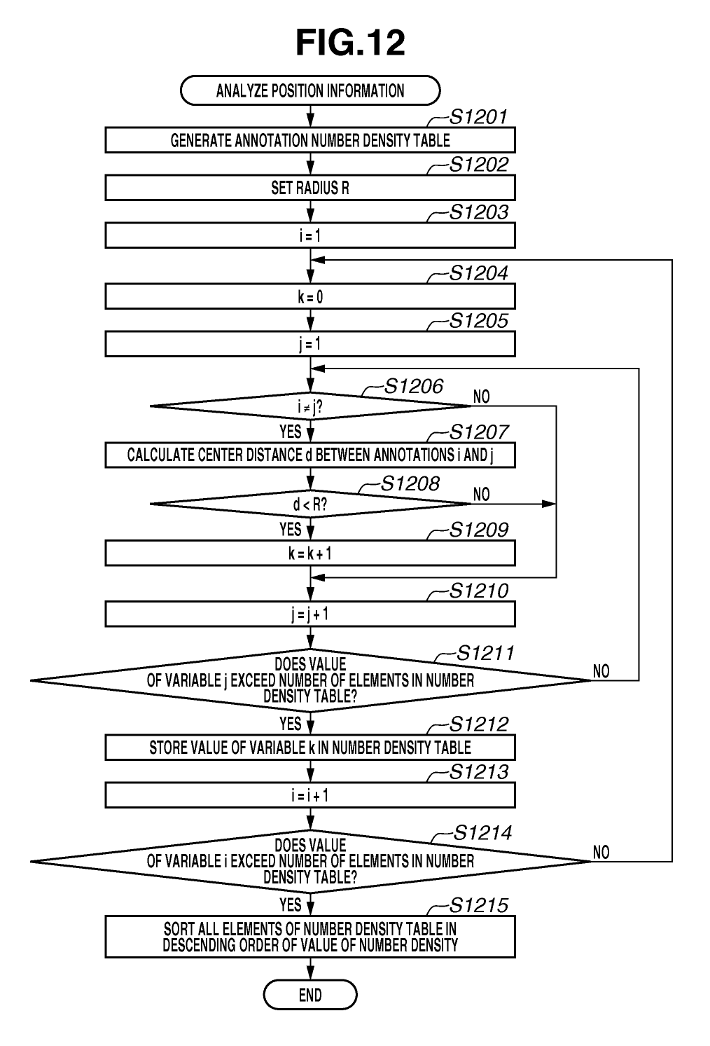

FIG. 12 is a flowchart illustrating an example of a detailed flow of position information update processing in step S604 according to the present exemplary embodiment. A description will be given below with reference to FIG. 12.

In step S1201, the information analysis unit 308 generates an annotation number density table (hereinafter, referred to as “number density table”) for storing annotation number densities. The number density table is a table including the ID numbers of respective annotations and the number densities around the corresponding annotations. At this point in time, the values of the number densities are not calculated yet. The information analysis unit 308 thus sets the number densities to a certain value such as zero.

In step S1202, the information analysis unit 308 sets a radius R needed for the number density calculation. The user may set the value of the radius R in advance. The program may automatically set the value of the radius R based on some information.

In step S1203, the information analysis unit 308 prepares an integer variable i and sets the variable i to one.

In step S1204, the information analysis unit 308 prepares an integer variable k and sets the variable k to zero.

In step S1205, the information analysis unit 308 prepares an integer variable j and sets the variable j to one.

In step S1206, the information analysis unit 308 determines whether i and j have different values. If the information analysis unit 308 determines that i and j have the same values (NO in step S1206), the processing proceeds to step S1210. If the information analysis unit 308 determines that i and j have the different values (YES in step S1206), then in step S1207, the information analysis unit 308 calculates a center distance d between annotations i and j.

In step S1208, the information analysis unit 308 determines whether the value of d is smaller than the radius R. If the information analysis unit 308 determines that the value of d is smaller than the radius R (YES in step S1208), then in step S1209, the information analysis unit 308 determines that annotation j is in the vicinity of annotation i, and increases the value of the variable k by one. If the information analysis unit 308 determines that the value of d is not smaller than the radius R (NO in step S1208), the processing proceeds to step S1210.

In step S1210, the information analysis unit 308 increases the value of the variable j by one.

In step S1211, the information analysis unit 308 determines whether the value of the variable j exceeds the number of elements in the number density table. If the information analysis unit 308 determines that the value of the variable j does not exceed the number of elements in the number density table (NO in step S1211), the processing returns to step S1206. If the information analysis unit 308 determines that the value of the variable j exceeds the number of elements in the number density table (YES in step S1211), then in step S1212, the information analysis unit 308 stores the value of the variable k as the element corresponding to annotation i of the number density table.

In step S1213, the information analysis 308 increases the value of the variable i by one.

In step S1214, the information analysis unit 308 determines whether the value of the variable i exceeds the number of elements in the number density table. If the information analysis unit 308 determines that the value of the variable I does not exceed the number of elements in the number density table (NO in step S1214), the processing returns to step S1214 to continue number density calculation processing. If the information analysis unit 308 determines that the value of the variable i exceeds the number of elements in the number density table (YES in step S1214), the processing proceeds to step S1215 since there is no annotation left to calculate the number density of. In step S1215, the information analysis unit 308 sorts all the elements of the number density table in descending order of the value of the number density. The information analysis unit 308 generates a list of annotation ID numbers from the sort result, and passes the list to the buffering priority setting unit 309. The buffering priority setting unit 309 uses the passed list when updating the buffering priority table in step S605.

That is the end of the detailed description of FIG. 12.

If it is clear that the application of this step S604 results in no change from before the processing, the processing of step S604 itself may be omitted as far as appropriate. Specific examples include when the value of the radius R is unchanged and when the number of annotations does not vary.

### <Example of Buffering>

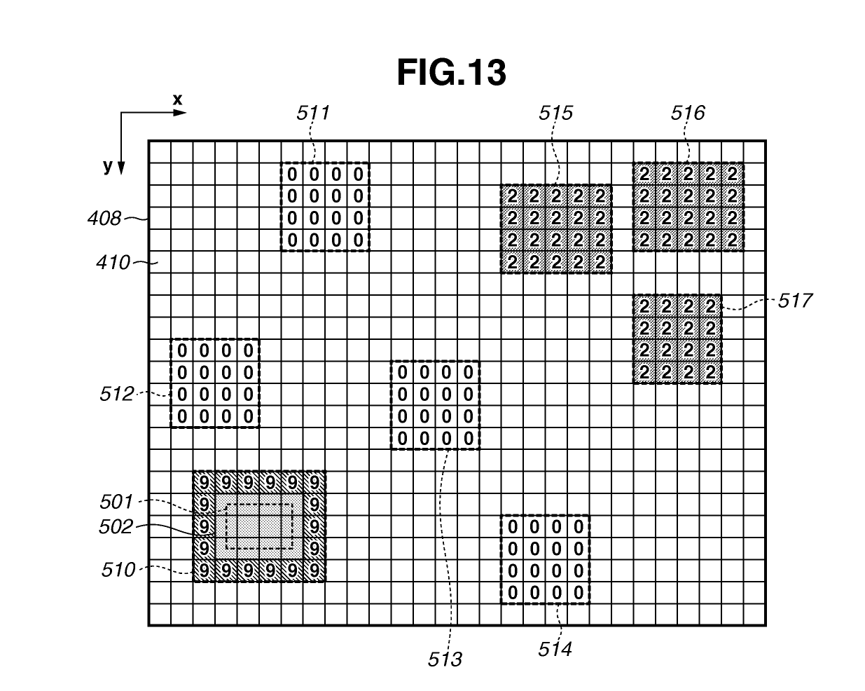

FIG. 13 is a schematic diagram illustrating a state where buffering priorities are set by the method described according to the present exemplary embodiment. In FIG. 13, a buffering priority of “2” is set for the block image data 410 belonging to the buffering target regions 515 to 517. The values of the number densities when a radius R of 800 pixels is set in FIG. 12 are simply used as the values of the buffering priorities. Similar to the first exemplary embodiment, the present exemplary embodiment employs the assumption that the screen display region 501 is more likely to be moved by scrolling up, down, right, or left than by jumping to other distant regions.

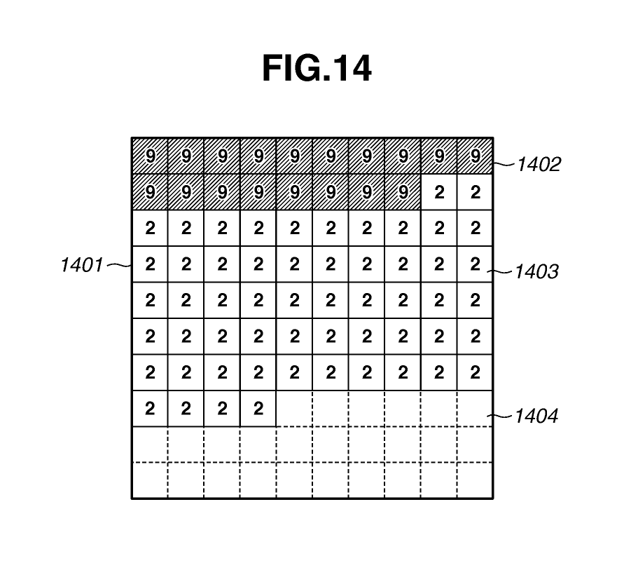

FIG. 14 illustrates how block image data groups are stored in the buffer unit 303 when the foregoing priority is set. In the situation illustrated in FIG. 14, a buffer area 1401 has a size greater than the total sum of the block image data 410 to be buffered. There is a free space 1404 even if all the block image data 410 is stored in the buffer unit 303. As for the order of storage into the buffer unit 303, a block image data group 1402 having a higher buffering priority is stored first before a block image data group 1403.

The pieces of block image data 410 in the block image data group 1403 all have the same buffering priorities. Such buffering priorities may be re-adjusted to make new differences in priority within the block image data group 1403. For example, a history of the number of times each piece of block image data 410 is displayed in the past may be recorded, and buffering priorities may be made different according to such values. More specifically, the more frequently an image is referred to in the past, the more likely the image may be to be referred to again. According to such assumption, higher priorities can be assigned to pieces of block image data 410 of which the number of times of display is greater. This is considered to be effective for ordinary detailed diagnosis. The less frequently an image is referred to in the past, the more likely the image may be to be referred to again. According to such assumption, higher priorities can be assigned to pieces of block image data 410 of which the number of times of display is smaller. This is considered to be effective for situations where all the images are displayed in order in a comprehensive manner like screening.

In the present exemplary embodiment, similar to the first exemplary embodiment, the positions of the annotations may be expressed by three-dimensional coordinates, and the number densities may be calculated based thereon.

As described above, the buffering control according to the present exemplary embodiment enables buffering of image data with high memory use efficiency according to the characteristics of the pathological diagnosis as compared to the conventional technique. As a result, the display response of the image viewer improves. More specifically, the position information about the annotation data accompanying the pathological images can be analyzed and the buffering priorities of image data on regions where annotations are relatively concentrated can be increased to enable buffering processing with memory use efficiency higher than heretofore.

A third exemplary embodiment of the present invention will be described with reference to the drawings.

An outline of the system configuration, hardware configuration, functional blocks, and processing algorithm is similar to that of the first exemplary embodiment. A difference lies in the condition for the analysis of position information about annotations.

In the first exemplary embodiment, the buffering priorities of the images around the annotations 503 to 509 are determined according to the distances from the screen display region 501. In the second exemplary embodiment, the buffering priorities of the images around the annotations are determined according to the values of the annotation number densities. In the present exemplary embodiment, the buffering priorities of the images are determined according to a combination of position information about annotations and pathological information accompanying the annotations. The pathological information accompanying an annotation includes a plurality of pieces of information about pathological diagnosis. The consideration of such information enables image buffering more appropriate for pathological diagnosis applications.

The present exemplary embodiment uses similar processing to that of the first exemplary embodiment as far as FIGS. 6, 7, and 9 are concerned. Specific processing for the analysis of position information in step S604 is different from that of the first exemplary embodiment. A flow of step S604 will be described below.

### <Analysis of Position Information in Step S604>

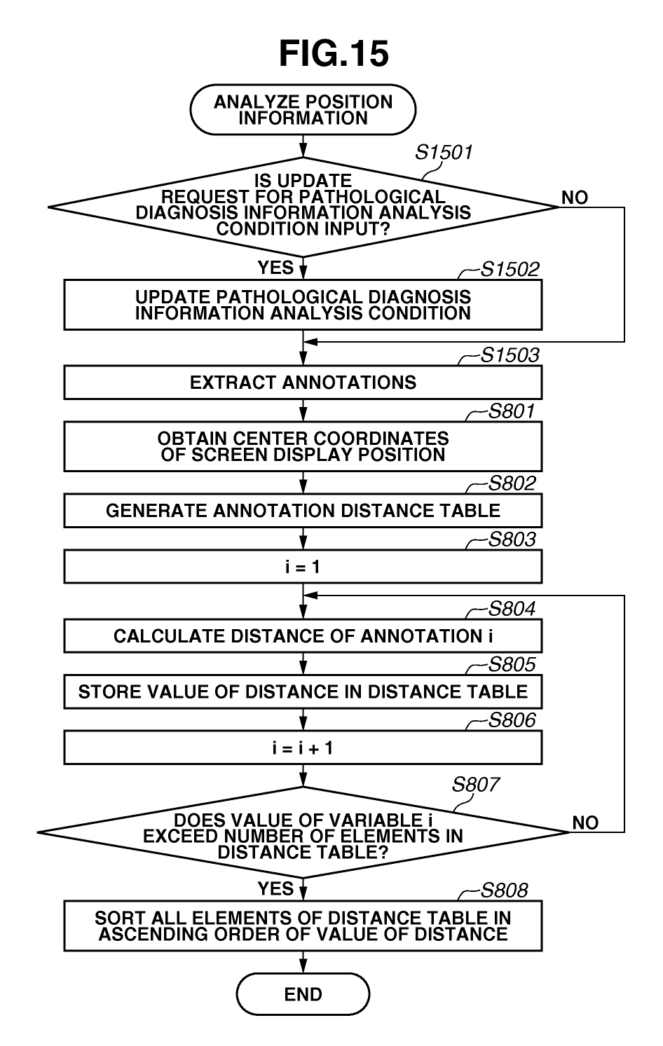

FIG. 15 is a flowchart illustrating an example of a detailed flow of position information update processing in step S604 according to the present exemplary embodiment. Referring to FIG. 15, a description will be given in conjunction with a specific example.

In step S1501, the annotation analysis condition setting unit 307 determines whether an update request for a pathological diagnosis information analysis condition of annotations is input to the image data forming apparatus 102 in the form of a user information. The update request for a pathological diagnosis information analysis condition refers to an operation of changing a condition to determine what analysis to perform on pathological diagnosis information accompanying the annotations and what buffering priority to set based on the analysis result. The user input may be input by a method similar to that described in step S602.

In the condition determination of step S1501, if an update request for a pathological diagnosis information analysis condition is determined to be input (YES in step S1501), then in step S1502, the annotation analysis condition setting unit 307 updates the pathological diagnosis information analysis condition based on the input. More specifically, the annotation analysis condition setting unit 307 rewrites data on the pathological diagnosis information analysis condition stored in the storage unit 202. In the present exemplary embodiment, the pathological diagnosis information analysis condition is set to extract annotations of which the creator is “Sakoda” from the annotation data illustrated in Table 1. If an update request for a pathological diagnosis information analysis condition is determined not to be input (NO in step S1501), the processing proceeds to step S1503.

In step S1503, the information analysis unit 308 extracts annotations according to the pathological diagnosis information analysis condition. In the present exemplary embodiment, three annotations having an annotation ID of 1, 2, and 6 are extracted at this point in time.

In FIG. 15, the information analysis unit 308 then performs the processing of steps S801 to S808, and ends the position information analysis processing. Though, in the first exemplary embodiment, the number of elements of the annotation distance table is the same as the number of annotations, in the present exemplary embodiment, the number of elements of the annotation distance table is three.

That is the end of the detailed description of FIG. 15.

If it is clear that the application of this step S604 results in no change from before the processing, the processing of step S604 itself may be omitted as far as appropriate.

### <Example of Buffering>

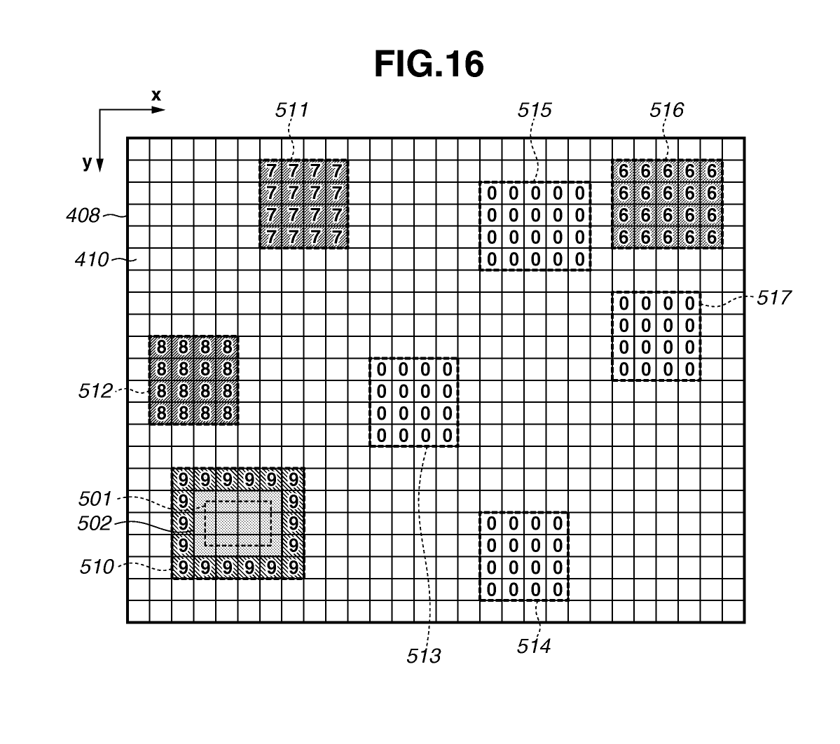

FIG. 16 is a schematic diagram illustrating a state where buffering priorities are set by the method described according to the present exemplary embodiment. In FIG. 16, priorities of “8”, “7”, and “6” are set for the block image data 410 belonging to the buffering target regions 512, 511, and 516, respectively. Similar to the first exemplary embodiment, the present exemplary embodiment employs the assumption that the screen display region 501 is more likely to be moved by scrolling up, down, right, or left than by jumping to other distant regions.

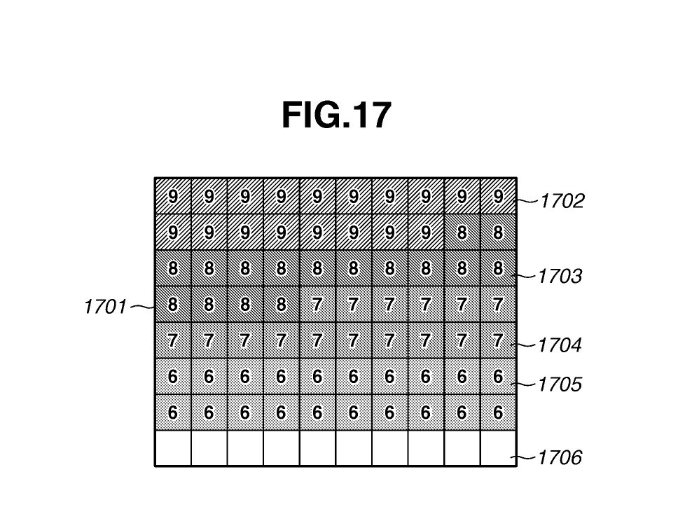

FIG. 17 illustrates how block image data groups are stored in the buffer unit 303 when the foregoing priority is set. In the situation illustrated in FIG. 17, a buffer area 1701 has a size greater than the total sum of the block image data 410 to be buffered. There is a free space 1706 even if all the block image data 410 is stored in the buffer unit 303. The order of storage into the buffer unit 303 is such that a block image data group 1702 having a higher buffering priority is stored first before block image data groups 1703, 1704, and 1705.

In the present exemplary embodiment, a creator is specified to narrow down annotations before the buffering priorities are set by using distance information. However, the buffering priorities may be set by using number density information instead of the distance information. A keyword search may be performed on diagnostic comments, instead of creators, to narrow down annotations before the buffering priorities are set by using the distance information or the number density information. The buffering priorities may be set by a combination of other pathological diagnosis information or a similar plurality of pieces of information with position information. Examples include the date of creation (date and time of creation) of an annotation, automatic diagnostic information, an updater, and the date of update (date and time of update). A plurality of pieces of pathological diagnosis information may be combined by an AND condition or an OR condition.

In the present exemplary embodiment, similar to the first exemplary embodiment, the positions of the annotations may be expressed by three-dimensional coordinates, and number densities may be calculated based thereon.

As described above, the buffering control according to the present exemplary embodiment enables buffering of image data with high memory use efficiency according to the characteristics of the pathological diagnosis as compared to the conventional technique. As a result, the display response of the image viewer improves. More specifically, the buffering priorities of the image data are determined in consideration of the pathological diagnosis information as well as the position information about the annotation data accompanying the pathological images. This enables buffing processing that is more suitable for pathological diagnosis than heretofore and has high memory use efficiency.

A fourth exemplary embodiment of the present invention will be described with reference to the drawings.

An outline of the system configuration, hardware configuration, functional blocks, and processing algorithm is similar to that of the first exemplary embodiment. A difference lies in the condition for the analysis of position information about annotations.

In the first exemplary embodiment, the buffering priorities of the images around the annotations 503 to 509 are determined according to the distances from the screen display region 501. In the second exemplary embodiment, the buffering priorities of the images around the annotations are determined by the values of the annotation number densities. In the present exemplary embodiment, a high buffering priority is set for a region that includes a plurality of annotations selected in advance according to a certain criterion or criteria. The purpose is to simulate a diagnostic flow of actual pathological diagnosis in which an operator puts a plurality of marks on the prepared slide with a marker pen to draw attention of the pathologist to inside the plurality of marks. In such a case, the region inside the plurality of marks is more likely to be referred to than other regions. In the present exemplary embodiment, annotations associated with pathological images are considered as corresponding to such “marks”.

The present exemplary embodiment uses similar processing to that of the first exemplary embodiment as far as FIGS. 6, 7, and 9 are concerned. Specific processing of the analysis of position information in step S604 is different from that of the first exemplary embodiment. A flow of step S604 according to the present exemplary embodiment will be described below.

### <Analysis of Position Information in Step S604>

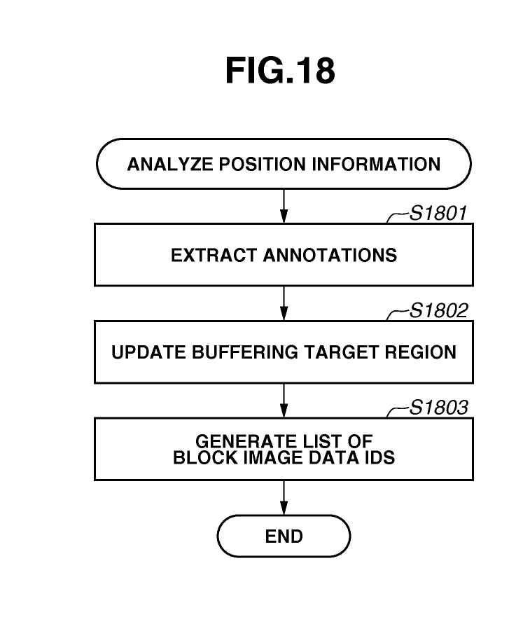

FIG. 18 is a flowchart illustrating an example of a detailed flow of position information update processing in step S604 according to the present exemplary embodiment. Referring to FIG. 18, a description will be given below in conjunction with a specific example.

In step S1801, the information analysis unit 308 extracts annotations satisfying a condition from the prepared annotation data. More specifically, for example, the information analysis unit 308 extracts annotations of which the creator is “Sakoda” and the date of creation is Dec. 18, 2012, from the annotation data illustrated in Table 1. Through such processing, the annotations having an ID number of 1 and 2 are extracted from the annotation data of Table 1. The annotations correspond to the annotations 503 and 504 in FIG. 5, respectively.

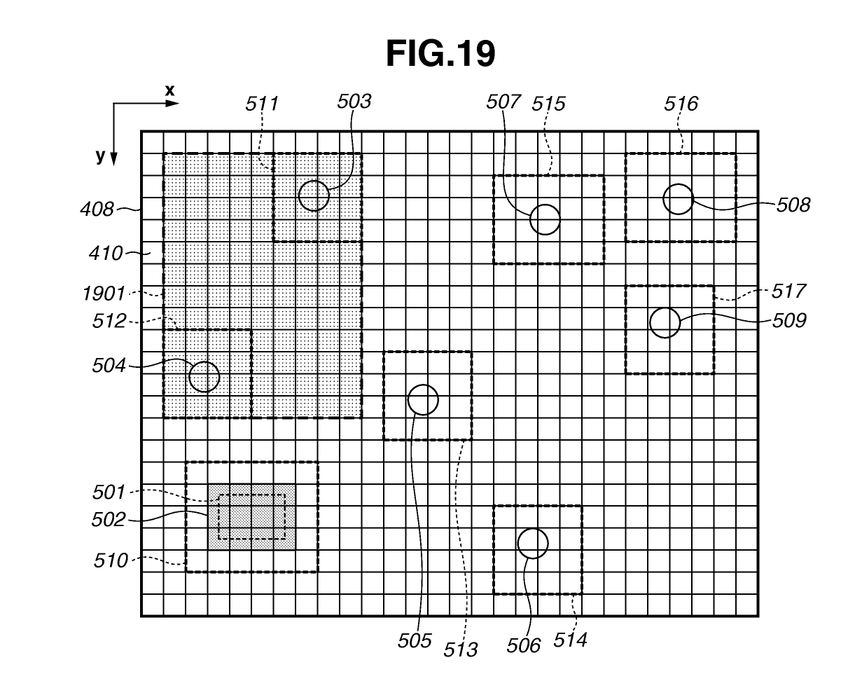

In step S1802, the information analysis unit 308 performs update so that a region that includes the annotations extracted in step S1801 and all the buffering target regions belonging thereto is set as a new buffering target region. More specifically, the information analysis unit 308 sets a rectangular region that completely includes the buffering target region 511 associated with the annotation 503 and the buffering target region 512 associated with the annotation 504 and has a minimum area, as a new buffering target region. FIG. 19 illustrates the setting. A buffering target region 1901 is the new buffering target region set in step S1802.

In step S1803, the information analysis unit 308 generates a list of block image data IDs included in the new buffering target region set in step S1802. More specifically, the information analysis unit 308 obtains the ID numbers of the pieces of block image data 410 included in the buffering target region 1901 and generates a list of the ID numbers. The information analysis unit 308 passes the list to the buffering priority setting unit 309. The buffering priority setting unit 309 uses the passed list when updating the buffering priority table in step S605.

That is the end of the detailed description of FIG. 18.

### <Example of Buffering>

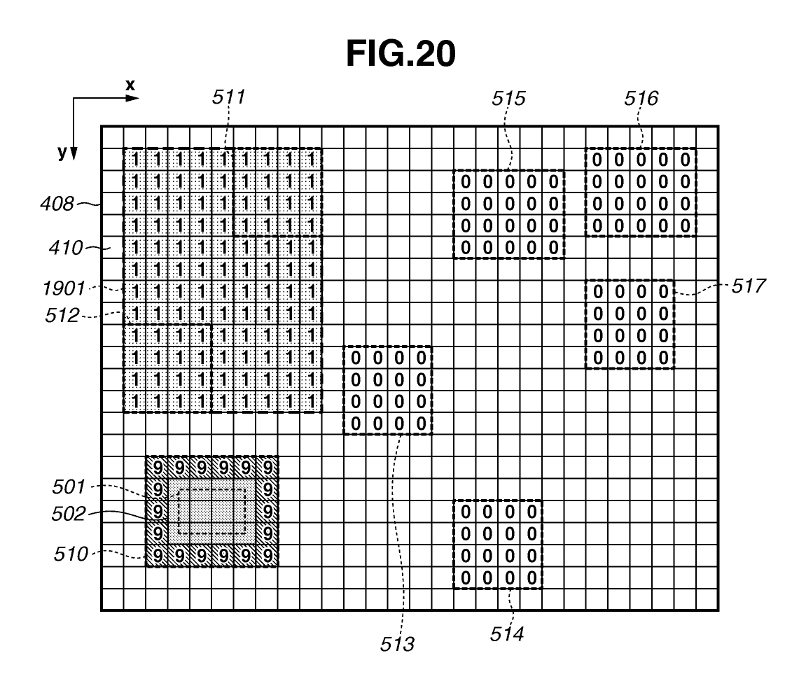

FIG. 20 is a schematic diagram illustrating a state where buffering priorities are set by the method described in the present exemplary embodiment. In FIG. 20, a buffering priority of “1” is set for the block image data 410 belonging to the buffering target region 1901 which includes the buffering target regions 511 and 512. Similar to the first exemplary embodiment, the present exemplary embodiment employs the assumption that the screen display region 501 is more likely to be moved by scrolling up, down, right, or left than by jumping to other distant regions. A buffering priority of “9” is thus set for the block image data 410 belonging to the buffering target region 510. The buffering priority of the block image data 410 belonging to the buffering target region 510 may be set to a number other than “9” as long as the number is higher than the buffering priorities of the block image data 410 belonging to the other buffering target regions 511 to 517.

With the foregoing priority settings, similar to the first and second exemplary embodiments, the block image data group to which the buffering priority of “9” is assigned is initially stored in the buffer unit 303. The block image data group to which the buffering priority of “1” is assigned is then stored in the remaining free space of the buffer unit 303. The buffer unit 303 may run short of the free space in the process of storing the block image data group to which the buffering priority of “1” is attached into the buffer unit 303. In such a case, the buffering processing is aborted at the point in time. Which pieces of block image data 410 to buffer first in the block image data group to which the buffering priority of “1” is assigned may be determined based on other criteria. More specifically, the simplest method may be to use the ID numbers of the pieces of block image data 410. Distances between the pieces of block image data 410 and the current screen display region 510 may be used. As described in the second exemplary embodiment, the history of the number of times each piece of block image data 410 has been displayed may be used.

In the present exemplary embodiment, a rectangular region including annotations extracted according to a predetermined condition and all buffering target regions belonging thereto is set as a new buffering target region. However, a buffering target region may be set by using other methods. For example, a block image data group completely included within a polygon that is formed by connecting the center coordinates of three or more extracted annotations may be set as a new buffering target region. A block image data group completely included within a circle that includes all the center coordinates of the extracted annotations and has a minimum radius may be set as a new buffering target region. A new buffering target region does not necessarily need to include the extracted annotations themselves. A region somewhat greater than one including all the extracted annotations may be set as a new buffering target region. A buffering target region may be set by using other similar appropriate methods. If there are only two extracted annotations, a region sandwiched between the two annotations may be set as a new buffering target region.

In the present exemplary embodiment, similar to the third exemplary embodiment, a plurality of pieces of pathological diagnosis information may be combined for analysis.

In the present exemplary embodiment, similar to the first and second exemplary embodiments, the positions of the annotations may be expressed by three-dimensional coordinates, and a new buffering target region may be set based thereon.

As described above, the buffering control according to the present exemplary embodiment enables buffering of image data with high memory use efficiency according to the characteristics of the pathological diagnosis as compared to the conventional technique. As a result, the display response of the image viewer improves. More specifically, after the extraction of a plurality of annotations, the buffering priority of a region including the block image data 410 around the annotations is increased. In such a manner, marking operations performed in pathological diagnosis can be simulated to enable buffering processing with memory use efficiency higher than heretofore.

### <Other System Configurations>

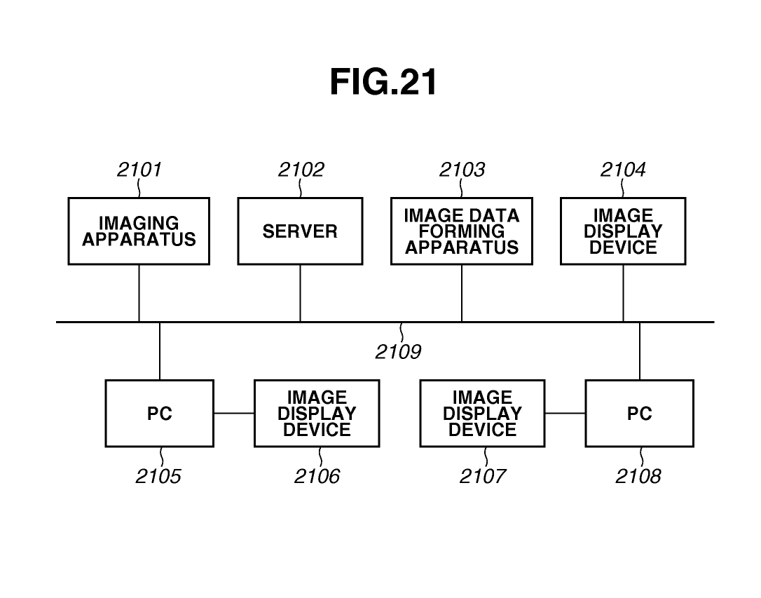

In the foregoing first to third exemplary embodiments, the image processing system includes the imaging apparatus 101, the image data forming apparatus 102, and the image display device 103 as illustrated in FIG. 1. However, the system configuration is not limited thereto. For example, as illustrated in FIG. 21, the system configuration may include a plurality of apparatuses connected via a network. An imaging apparatus 2101 mainly corresponds to an imaging unit of a virtual slide system. A server 2102 is a large-capacity storage (image server) that stores image data captured and generated by the imaging apparatus 2101. An image data forming apparatus 2103 is a main unit for implementing a technique described in the present exemplary embodiment. The image data forming apparatus 2103 reads and processes the image data stored in the server 2102. An image display device 2104 receives and displays the image data processed by the image data forming apparatus 2103 on-screen. Personal computers (PCs) 2105 and 2108 are ordinary PCs connected to a network. Image display devices 2106 and 2107 are connected to the PCs 2105 and 2108. A network line 2109 is used to exchange various types of data. Even with such a system configuration, the buffering control described in the first to third exemplary embodiments can be performed to improve the display response of each of the image display devices 2103, 2106, and 2107.

While some exemplary embodiments of the present invention have been described above, the present invention is not limited to such exemplary embodiments, and various changes and modifications can be made without departing from the gist thereof.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application 2013-230366 filed Nov. 6, 2013, and No. 2014-100828 filed May 14, 2014, which are hereby incorporated by reference herein in their entirety.

What is claimed is:

1. An image data forming apparatus configured to form image data for display from original image data, the image data forming apparatus comprising:
a storage unit configured to store the original image data;
a buffer unit configured to be capable of temporarily storing a part of the original image data;
an output unit configured to form the image data for display from the original image data and output the image data for display, and configured to use, if data needed to form the image data for display is stored in the buffer unit, the needed data stored in the buffer unit;
a priority setting unit configured to divide the original image data into a plurality of blocks and set priorities for respective blocks of the plurality of blocks;
a control unit configured to perform control so that image data of those blocks having a high priority is stored in the buffer unit by priority; and
an information analysis unit configured to analyze, if the original image data is accompanied by data of a plurality of annotations, position information about the plurality of annotations,
wherein the priority setting unit is configured to set the priorities based on an analysis result of the information analysis unit.

2. The image data forming apparatus according to claim 1, wherein the information analysis unit is configured to determine distances between positions of the plurality of annotations and a position of the image data for display displayed on an image display device, and
wherein the priority setting unit is configured to set the priorities based on the distances.

3. The image data forming apparatus according to claim 1, wherein the information analysis unit is configured to determine number densities each indicating the number of annotations lying around the annotation about the respective plurality of annotations, and
wherein the priority setting unit sets the priorities based on the number densities.

4. The image data forming apparatus according to claim 3,
wherein the information analysis unit is configured to determine distances between positions of the plurality of annotations and a position of the image data for display displayed on an image display device, and the number densities, and
wherein the priority setting unit is configured to set the priorities based on the distances and the number densities.

5. The image data forming apparatus according to claim 1,
wherein the original image data is data on a pathological image obtained by capturing an image of a pathological sample, and
wherein each of the plurality of annotations is intended to associate information about pathological diagnosis with a position of the original image data.

6. The image data forming apparatus according to claim 5, wherein the information about the pathological diagnosis includes a creator, date of creation, date and time of creation, an updater, date of update, date and time of update, a comment, and/or automatic diagnostic information of each of the plurality of annotations.

7. The image data forming apparatus according to claim 5,
wherein the information analysis unit is configured to analyze the information about the pathological diagnosis of each of the plurality of annotations, and
wherein the priority setting unit is configured to determine the priorities based on an analysis result of the position information and an analysis result of the information about the pathological diagnosis.

8. The image data forming apparatus according to claim 7,
wherein the information analysis unit is configured to analyze the information about the pathological diagnosis and extract a plurality of annotations satisfying a predetermined analysis condition from the plurality of annotations,
wherein the information analysis unit is configured to define a region base on position information about the plurality of annotations extracted by the information analysis unit, and
wherein the priority setting unit is configured to set a priority for the region.

9. The image data forming apparatus according to claim 8, wherein the region is a region including the plurality of annotations extracted by the information analysis unit.

10. The image data forming apparatus according to claim 8, wherein the region is a region that does not include the plurality of annotations extracted by the information analysis unit.

11. The image data forming apparatus according to claim 8, wherein, if the information analysis unit extracts two annotations, the region includes a region sandwiched between the two annotations.

12. The image data forming apparatus according to claim 8, wherein, if the information analysis unit extracts three or more annotations, the region includes a region surrounded by the three or more annotations.

13. An image data forming method for an image data forming apparatus configured to form image data for display from original image data, the image data forming method comprising:
storing the original image data;
temporarily storing, in a buffer unit, a part of the original image data;
forming the image data for display from the original image data and outputting the image data for display, and using, if data needed to form the image data for display is stored in the buffer unit, the needed data stored in the buffer unit;
dividing the original image data into a plurality of blocks and setting priorities for respective blocks of the plurality of blocks;
performing control so that image data of those blocks having a high priority is stored in the buffer unit by priority; and
analyzing, if the original image data is accompanied by data of a plurality of annotations, position information about the plurality of annotations,
wherein setting the priorities includes setting the priorities based on an analysis result of analyzing the position information about the plurality of annotations.

14. A non-transitory computer-readable storage medium storing a program to cause an image data forming apparatus to perform the image data forming method according to claim 13.
